(19) United States
(12) Patent Application Publication
(10) Pub. No.: US 2013/0122142 A1
(43) Pub. Date: May 16, 2013

(54) Fermentation Pressure Relief, Anti-Oxidation and Visual Observation Apparatus and Method

(71) Applicant: Henry J. Bowers, Glenville, NY (US)

(72) Inventor: Henry J. Bowers, Glenville, NY (US)

(21) Appl. No.: 13/737,071

(22) Filed: Jan. 9, 2013

Related U.S. Application Data
(60) Provisional application No. 61/735,747, filed on Dec. 11, 2012.

(51) Int. Cl. F16K 17/02

(52) U.S. Cl. CPC F16K 17/02
USPC 426/11; 137/505.11; 137/12

(57) ABSTRACT

A fermentation pressure relief, anti-oxidation and visual observation apparatus and related method, comprising: a collar with an opening therethrough capable of sealably mating to a fermentation vessel lid atop a fermentation vessel; and a flap attached to the collar via a flap-to-collar attachment and situated atop the collar opening to seal the opening when substantially no upward pressure subsists against the flap such that entry of air or other matter downward through the opening is substantially barred; wherein, when the apparatus is attached to the fermentation vessel lid: when pressure subsists within the fermentation vessel the pressure causes the flap to slightly separate from the collar opening and is thereby is permitted to bleed out between the flap and the collar opening through the separation; and after the pressure has bled out the separation is reversed and the flap reverts to a position wherein it again seals the opening, by virtue of the pressure having been bled out.

### CROSS-REFERENCE TO RELATED APPLICATIONS

This application claims benefit of pending U.S. provisional application 61/735,747 filed Dec. 11, 2012, which is hereby fully incorporated by reference into this application.

### BACKGROUND OF THE INVENTION

One of the most popular fermentation vessels for brewing fermented beverages being used today consists of an opaque bucket or pail with a tightly affixed opaque lid into which is fitted with an airlock. The airlock is a small device that allows gas to escape through a liquid filled, narrow diameter convoluted tube.

Specifically, the fermenting process causes a thick foamy product to form on the surface of the beer as it is fermenting. This is called krausen.

This krausen often exceeds the volume of the fermenting bucket and causes problems, which can vary from beer-splattered ceilings to messy floods.

The current lids on fermenting buckets have a small hole drilled in them where a gasket is inserted and into the gasket is placed an airlock, which is a small liquid filled device that allows carbon dioxide to escape while keeping outside air from getting into the bucket. If the krausen reaches this airlock it clogs and pressure builds until the lid pops causing the above problems. Samples of the beer as it is fermenting are often taken during the various stages and this requires opening the lid on the fermenter allowing introduction of air and the possibility of contamination.

The current lids are opaque and do not allow any visual inspection of the beer's progress unless once again the lid is removed.

Additions of ingredients into the fermenter also require popping the lid and again possibly causing problems.

Thus, following are some of the problems using such prior art fermenter and airlock systems:

1. Airlocks can easily and often do become clogged. This can lead to excessive pressure from the production of carbon dioxide in the fermenting vessel. This pressure may push through the clogged airlock spraying the vessel's contents into the surrounding area. If the clog in the airlock is not blown out the pressure can build to where it blows the entire lid off the bucket causing very messy and possibly dangerous results.

2. Airlocks are also used to verify that the fermentation process is taking place. Gas bubbling through the airlock shows the production of carbon dioxide indicating active fermentation. This check for activity can only take place if the lid forms a true airtight seal with the bucket and there is an airtight seal where the airlock is inserted. If carbon dioxide escapes through the bucket-lid seal or the airlock seal the airlock will not show activity and fermentation cannot be verified.

3. If there is a failure in the bucket-lid seal and the airlock shows no activity the only other means of checking fermentation progress is through visual inspection. This removal and reapplication of the lid causes early deterioration of the sealant in the lid as well as deformation to both the lid and the bucket.

4. During the fermentation process access to the fermenting vessel is often required in order to add ingredients or to withdraw samples for testing. This is done by removing the lid from the bucket or pail. This removal and reapplication of the lid causes early deterioration of the sealant in the lid as well as deformation to both the lid and the bucket.

5. With the repeated removal and reapplication of lids the layer of carbon dioxide (often referred to as a CO2 blanket) that is formed in the fermenting vessel can be disturbed. If this layer of carbon dioxide is disturbed the fermenting liquid can come in contact with oxygen causing oxidation which will ruin the contents.

6. With the repeated removal and reapplication of the lid the removed lid as well as the entire surface of the fermenting liquid is exposed to airborne contaminants resulting in the possibility of infection.

### SUMMARY OF THE INVENTION

A fermentation pressure relief, anti-oxidation and visual observation apparatus and related method, comprising: a collar with an opening therethrough capable of sealably mating to a fermentation vessel lid atop a fermentation vessel; and a flap attached to the collar via a flap-to-collar attachment and situated atop the collar opening to seal the opening when substantially no upward pressure subsists against the flap such that entry of air or other matter downward through the opening is substantially barred; wherein, when the apparatus is attached to the fermentation vessel lid: when pressure subsists within the fermentation vessel the pressure causes the flap to slightly separate from the collar opening and is thereby is permitted to bleed out between the flap and the collar opening through the separation; and after the pressure has bled out the separation is reversed and the flap reverts to a position wherein it again seals the opening, by virtue of the pressure having been bled out.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) summarized below.

FIG. 1 illustrates a preferred, non-limiting embodiment of applicant's fermentation gating system, with a flap thereof shown in a closed position to bar the entry of air into a fermentation bucket.

FIG. 2 illustrates fermentation gating system of FIG. 1, with the flap thereof shown in an open position to enable fermentation pressure and foam and other byproducts to naturally be released, and to enable direct viewing inside the fermentation bucket without having to remove the fermentation bucket lid.

FIG. 3 illustrates a preferred method by which the fermentation gating system of FIG. 1 is attached to the fermentation bucket lid.

FIG. 4 illustrates the fermentation gating system of FIG. 1 after it has been attached to the fermentation bucket lid.

FIG. 5 illustrates applicant's fermentation gating system in an alternative embodiment wherein the gating apparatus is manufactured integrally with the fermentation bucket lid.

FIG. 6 illustrates an alternative preferred embodiment of applicant's fermentation gating system, wherein the tether of FIG. 1 is replaced by a hinge.

### DETAILED DESCRIPTION

This device (the FermGate™) is designed to eliminate problems encountered in the fermenting process for home brewers, home wine makers or anyone using closed system fermenting vessels.

The basic process involved in the above endeavors is fermentation. Fermentation involves the conversion of sugars into alcohol.

The fermentation process produces several by-products such as carbon dioxide gas and often large amounts of foam.

A fermentation vessel must allow the escape of carbon dioxide and any excess foam. The vessel must also be designed so that once the fermentation process begins oxygen and other contaminants are prevented from entering into it, because these may cause oxidation or infection.

The apparatus disclosed entails a simple and inexpensive change in the design of the lid that goes on the fermenting bucket/vessel. While the volume problem could be solved by simply increasing the bucket size, that would still leave many of the other problems associated with the current lids, as described earlier.

Specifically, one incorporates a 2 to 3 to 4 to 5 inch hole in the lid with a (for example not limitation, silicon) gasket installed and a “flapper” (preferably but not limited to a clear plastic) hinged next to the gasket, similar to the internal flapper in a common bathroom commode. This would allow for several things not possible with the current lids.

1. It would provide one-way venting to allow gas to escape easily while keeping outside air from entering the system.

2. It would allow samples to easily drawn off without need to open the entire lid.

3. It would allow visual inspection via the clear plastic and/or raising of the flapper.

4. It would allow the easy introduction of brewing ingredients into the system.

FIG. 1 illustrates a preferred, non-limiting embodiment of applicant's fermentation gating apparatus 1. The elements of this are as follows:

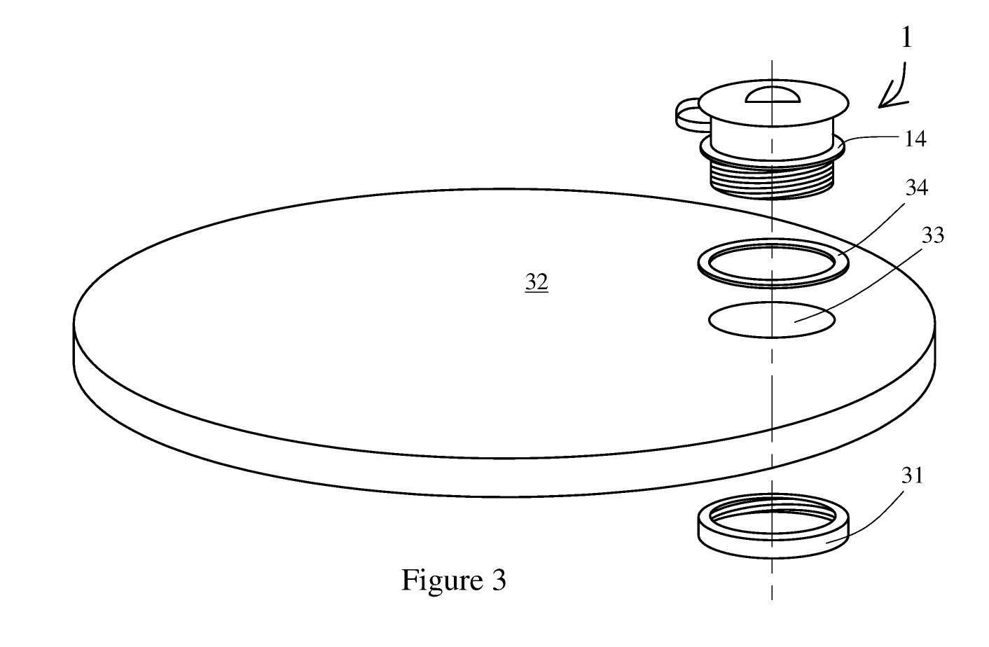

A. The upper 11 and lower 12 collar. A hollow cylinder of appropriate length and diameter as illustrated (such as but not limited to 2 to 3 to 4 to 5 inches in diameter) that is designed to be placed into an appropriately sized port 33 (hole) in the top of a fermenting vessel lid 32, see FIG. 3.

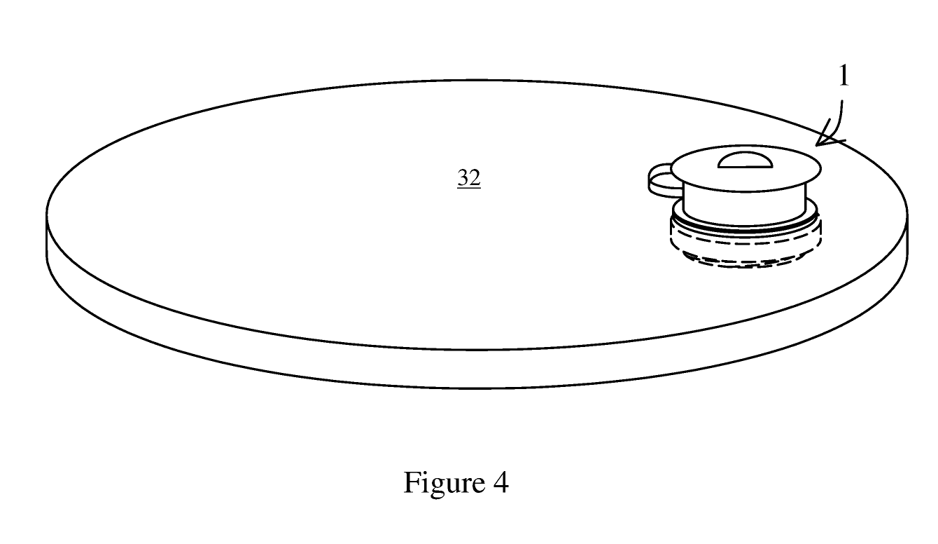

B. The flap 13. A circular weighted lid/valve that is designed to overlap the top opening of the cylinder, similar to that of a bathroom commode. C. The seal ring flange 14. An area where an airtight seal between the collar and the fermenting vessel is established, with our without a gasket 34 as is further illustrated in FIGS. 3 and 4.

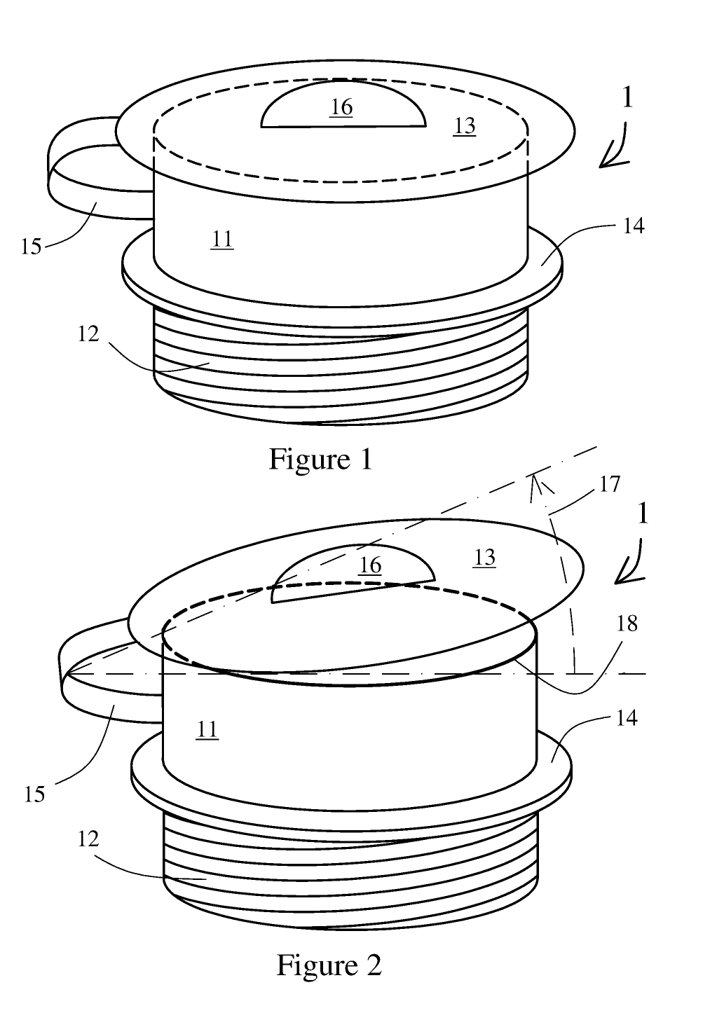

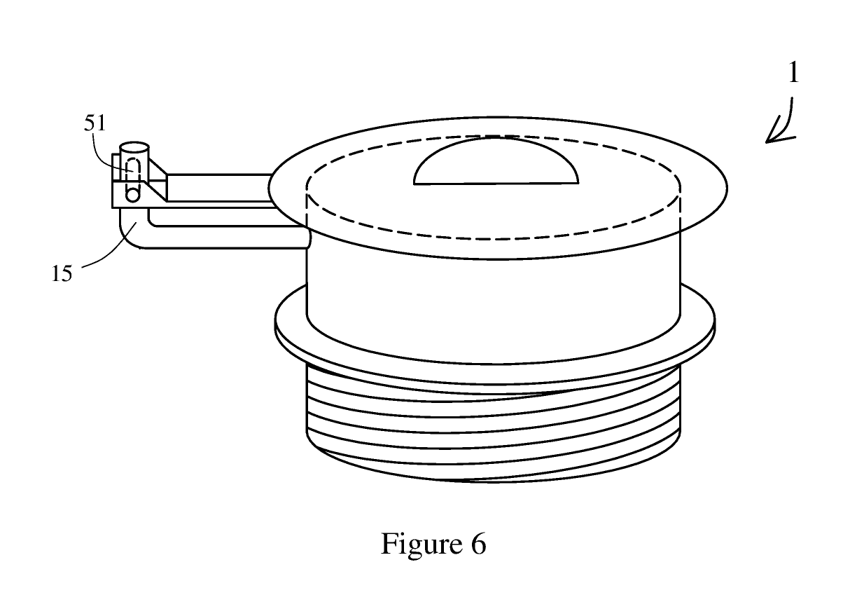

D. The flap-to-collar attachment 15. A mechanical (e.g., hinge, see FIG. 6) or non-mechanical (e.g., molded-in tether is in FIGS. 1 and 2) part of the FermGate™ that holds the flap 13 in proper alignment with the upper collar 11 allowing a proper seal to be maintained and which further allows a pivotal movement of flap 13 as generally indicated by the arc segment 17 in FIG. 2.

In practice, when the flap 13 is rested against the top opening of the collar/cylinder 11, and no pressure is applied vertically up or down, an airtight seal is formed, as shown in FIG. 1. If pressure builds up inside the fermenting vessel, the pressure naturally and without human intervention causes the flap 13 to slightly lift 17 so it can bleed out between the flap 13 and the top opening of the collar/cylinder 11 through the separation, as shown in FIG. 2. After the pressure is released the airtight seal is naturally reestablished without human intervention and the configuration reverts to that of FIG. 1.

The FermGate™ is designed as such:

The collar 11, 12 preferably, but without limitation, has an internal diameter of at least 3 to 3.5 inches, which allows access for sampling as one of several benefits of this apparatus. It is fabricated so its lower portion 12 is threaded as illustrated and of the proper length to accept a suitable washer or gasket 34 and a proper nut 31 as shown in FIG. 3 for completing the airtight seal. Alternatively to threading, a rubberized seal making a frictional seal with the lid 32 of the fermentation vessel may be employed.

There is a band where the upper collar 11 meets the lower collar 12. This band, the seal ring flange 14, is designed to provide a firm bearing surface against the outer lid 32 of the fermenter when a nut 31 on the lower collar is tightened from the inner side of the fermenting vessel's lid 32, again see FIG. 3.

Importantly, the upper collar 11 is made so its top edge circumferential about the opening provides a smooth and level and sealable contact surface for the flap 13. This may optionally include providing a suitable gasket-grade sealing material 18 (illustrated by the thicker drawing line in FIG. 2) about this top circumferential edge.

The flap 13 is made so it overlaps the diameter of the upper collar 11, completely and sealably covering it. It has a tab 16 molded into it for gripping. This allows the flap 13 to be lifted without touching the area where the flap 13 contacts the upper collar 11. This ensures a sanitary seal by avoiding the introduction of bacteria or other foreign matter from the user's hand. When the tab 16 is employed the flap 13 may be pivoted through a larger arc of rotation than that illustrated in FIG. 2. Generally, the tab will only be used to lift the flap 13 when the use wishes to inspect the contents, draw samples, and/or make additions of ingredients to the fermenting brew. Otherwise, the only time when the seal shown in FIG. 1 between the flap 13 and the upper collar 11 will be broken as in FIG. 2 is when the fermentation pressure itself causes the separation and bleeds out.

The flap 13 is designed to be of sufficient weight to produce an adequate seal.

The flap 13 is attached 15 to the upper collar 11 so that it is held level and in the proper alignment with the rim of the upper collar 12 for a good seal against passive contamination from outside the system. This attachment 15 can be done in several ways including but not limited to a snap on type pivot hinge 51 as in FIG. 6 or a simple tether arrangement as in FIG. 1.

The FermGate™ and all its parts are made from materials that are food safe and durable enough to withstand repeated use. These materials, including but not limited to liquid silicon rubber and stainless steel, are such that the FermGate™ can be easily cleaned and sanitized. The design is such that there are no places that might harbor dirt or bacteria.

Referring to FIG. 3, for retrofitting to preexisting fermenting vessels the FermGate™ is inserted into a port (hole) 33 introduced into the cover 32 of the fermenting system, with hole 33 sized to mate tightly with the outer circumference of the FermGate™ 1, and is held in place with a nut 31 screwed onto the threaded lower collar 12. Preferably, a washer or gasket 34 is placed between the seal ring flange 14 and the top of the cover 32 and helps form the required airtight seal. Once these steps are complete, the resulting configuration is that of FIG. 4.

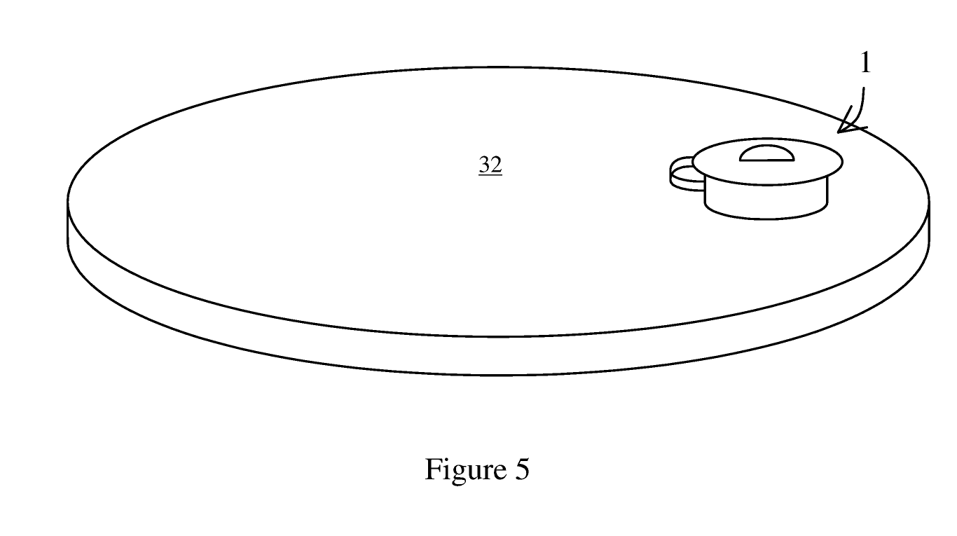

As just illustrated, the FermGate™ is designed so it can easily be retrofitted into existing fermenting systems. But it may also be fabricated according to the principles outlined herein into new systems at the time of their manufacture. All that is required is a lid 32 with a port (hole) 33 of FIG. 3 of the proper diameter integrally fabricated with the FermGate™. This is illustrated in FIG. 5.

To draw samples, make additions or to make visual observations the flap 13 is lifted using the tab 16 then dropped back in place by releasing the tab 16 when done.

To clean or sanitize the FermGate™ once the fermentation is finished, one only needs to soak the apparatus in any commonly used cleanser and/or in any of the commonly-available sanitizers.

Depending on manufacturing methods there can be several variations in the collar's design. Some variations may omit the seal ring flange 14. In such variations the entire upper collar 11 is constructed of a thicker wall to ensure a strong bearing surface for the nut 31 and sealing washer 34 when the washer 34 is tightened on the inside of the fermenter. The gasket 34 may be added to facilitate an airtight seal at the point where the collar 11, 12 inserts into the fermenter lid 32, although it is envisioned that in some embodiments the seal ring flange 14 may integrally include suitable materials for sealing so that a separate washer 34 may be omitted.

Other variations may include a seal ring flange 14 such as is illustrated in FIG. 1, but with the lower collar 12 having no threading. Depending on the material it is made of it could be inserted using any number of ways to maintain a seal, such as via a frictional contact.

When applicant's fermentation gating system (FermGate™) is installed, the problems with the prior art are solved as follows:

1. There is no possibility of a dangerous pressure build up in the fermenting vessel, since there is nothing that can become clogged. If there should be an overly large formation of foam, causing it to overflow the FermGate™'s upper collar 11, the designed height of the FermGate™'s upper collar 11 as well as the design of the flap 13 will prevent the overflow from re-entering and possibly contaminating the vessel's contents. It is essentially a one-way valve permitting outflow but not inflow. The design of the FermGate™ also makes cleanup from accidental overflows an easy chore while still maintaining a sanitary closed system.

2. In the event of any minor leaks in the seal between the bucket and lid or a minor leak where the airlock is inserted active fermentation can be verified with a simple visual inspection.

3. There is no need to constantly remove the lid from the fermenting vessel. Once the lid is in place it can stay in place until the finished product is removed and the fermenting vessel can then be cleaned and reused. This will greatly add to the life span of the fermenting equipment.

4. The addition of ingredients or the withdrawal of samples is simple, fast and sanitary without the need to remove the lid.

5. Since the FermGate™'s port is elevated away from the fermenting liquid's surface and is small in comparison to the entire vessel's surface the carbon dioxide layer (CO2 blanket) will remain relatively undisturbed. Any chance of oxidation will be greatly reduced if not totally eliminated. Any ambient air that may enter the collar when it is opened will be forced out by the heavier carbon dioxide being produced it the vessel.

6. The FermGate™'s port, when opened, presents a much smaller window of opportunity for airborne contamination than a bucket with the lid removed. This greatly reduces the possibility for infection.

The knowledge possessed by someone of ordinary skill in the art at the time of this disclosure, including but not limited to the prior art disclosed with this application, is understood to be part and parcel of this disclosure and is implicitly incorporated by reference herein, even if in the interest of economy express statements about the specific knowledge understood to be possessed by someone of ordinary skill are omitted from this disclosure. While reference may be made in this disclosure to the invention comprising a combination of a plurality of elements, it is also understood that this invention is regarded to comprise combinations which omit or exclude one or more of such elements, even if this omission or exclusion of an element or elements is not expressly stated herein, unless it is expressly stated herein that an element is essential to applicant's combination and cannot be omitted. It is further understood that the related prior art may include elements from which this invention may be distinguished by negative claim limitations, even without any express statement of such negative limitations herein. It is to be understood, between the positive statements of applicant's invention expressly stated herein, and the prior art and knowledge of the prior art by those of ordinary skill which is incorporated herein even if not expressly reproduced here for reasons of economy, that any and all such negative claim limitations supported by the prior art are also considered to be within the scope of this disclosure and its associated claims, even absent any express statement herein about any particular negative claim limitations.

Finally, while only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

I claim:

1. A fermentation pressure relief, anti-oxidation and visual observation apparatus, comprising:
a collar with an opening therethrough capable of sealably mating to a fermentation vessel lid atop a fermentation vessel; and
a flap attached to said collar via a flap-to-collar attachment and situated atop said collar opening to seal said opening when substantially no upward pressure subsists against said flap such that entry of air or other matter downward through said opening is substantially barred;
wherein, when said apparatus is attached to the fermentation vessel lid:
when pressure subsists within the fermentation vessel the pressure causes said flap to slightly separate from said collar opening and is thereby is permitted to bleed out between said flap and said collar opening through the separation; and
after the pressure has bled out the separation is reversed and said flap reverts to a position wherein it again seals said opening, by virtue of said pressure having been bled out.

2. The apparatus of claim 1, said flap-to-collar attachment comprising a pivot hinge.

3. The apparatus of claim 1, said flap-to-collar attachment comprising a tether.

4. The apparatus of claim 1, said flap comprising a tab for enabling a user to lift said flap from said opening.

5. The apparatus of claim 1, said collar comprising a seal ring flange circumferentially disposed exterior to said collar and separating an upper portion of said collar from a lower portion of said collar, for helping to sealably mate said collar to the fermentation vessel lid.

6. The apparatus of claim 5, further comprising a gasket for placement about said collar beneath said seal ring flange for further facilitating the seal between said collar and the fermentation vessel lid.

7. The apparatus of claim 1, said collar comprising a gasket-grade sealing material about a top circumferential edge thereof.

8. The apparatus of claim 1, a lower portion of said collar further comprising threading about an outer surface thereof.

9. The apparatus of claim 8, further comprising a nut capable of mating with said threading for tightly sealing said collar to the fermentation vessel lid.

10. The apparatus of claim 1, in combination with said fermentation vessel lid, wherein said apparatus is sealably mated with said fermentation vessel lid.

11. The apparatus of claim 1, in combination with said fermentation vessel lid, wherein said apparatus is sealably mated with said fermentation vessel lid by virtue of being integrally manufactured as part of said lid.

12. A method for relieving pressure, averting oxidation and conducting visual observation of fermentation, comprising:
sealably mating a collar with an opening therethrough to a fermentation vessel lid atop a fermentation vessel, said collar comprising a flap attached thereto via a flap-to-collar attachment and situated atop said collar opening;
substantially barring entry of air or other matter downward through said opening by virtue of said flap sealing said opening when substantially no upward pressure subsists against said flap;
when pressure subsists within the fermentation vessel, permitting said pressure to bleed out between said flap and said collar opening by virtue of said pressure causing said flap to slightly separate from said collar opening and bleed said pressure through the separation; and
after said pressure has bled, reverting said flap to a position wherein it again seals said opening by virtue of said pressure having been bled out.

13. The method of claim 12, said flap-to-collar attachment comprising a pivot hinge.

14. The method of claim 12, said flap-to-collar attachment comprising a tether.

15. The method of claim 12, further comprising a user lifting said flap from said opening using a tab of said flap.

16. The method of claim 12, further comprising helping to sealably mate said collar to the fermentation vessel lid using a seal ring flange circumferentially disposed exterior to said collar and separating an upper portion of said collar from a lower portion of said collar.

17. The method of claim 16, further comprising placing a gasket about said collar beneath said seal ring flange for further facilitating the seal between said collar and the fermentation vessel lid.

18. The method of claim 12, further comprising providing a gasket-grade sealing material about a top circumferential edge of said collar.

19. The method of claim 12, a lower portion of said collar further comprising threading about an outer surface thereof.

20. The method of claim 19, further comprising tightly sealing said collar to the fermentation vessel lid by mating a nut with said threading.

21. The method of claim 12, wherein said fermentation vessel lid is separate from said collar and said collar is sealably mated with said fermentation vessel lid.

22. The method of claim 12, wherein said fermentation vessel lid is integrally manufactured as part of said lid and is sealably mated with said fermentation vessel lid by virtue of said integral manufacture.

23. A fermentation method, comprising:
providing a fermentation vessel lid with a collar comprising an opening therethrough and a flap situated atop said opening and sealing said opening;
bleeding fermentation pressure out between said flap and said opening by causing said flap and said opening to separate when pressure is built up within a fermentation vessel by virtue of said pressure having built up; and
returning said flap to seal said opening after said pressure has been bled out by virtue of said pressure having been bled out.
